(19) United States
(12) Patent Application Publication
(10) Pub. No.: US 2011/0083277 A1
(43) Pub. Date: Apr. 14, 2011

(54) FOAM PAD

(76) Inventor: David HENSON, Belden, MS (US)

(21) Appl. No.: 12/889,868

(22) Filed: Sep. 24, 2010

Related U.S. Application Data
(60) Provisional application No. 61/249,713, filed on Oct. 8, 2009.

(51) Int. Cl. B68G 5/02

(52) U.S. Cl. 5/655.9

(57) ABSTRACT

A foam pad includes a plurality of pad sections for supporting body portions of a user in a use condition. Two of the pad sections are end sections constituted of a foam material having a predetermined density, and another of the pad sections is a middle section constituted of a foam material having a density different from the predetermined density. The middle section is interlocked with one of the pad sections and located between the end sections in the use condition for supporting at least one of the body portions of the user to a different extent than the end sections.

### CROSS REFERENCE TO RELATED APPLICATION

This application claims the benefit of U.S. Provisional Patent Application Ser. No. 61/249,713, filed Oct. 8, 2009, which is hereby incorporated by reference herein.

### FIELD OF THE INVENTION

The present invention generally relates to a foam pad, especially a mattress or mattress topper, having interlocking foam sections of differing stiffnesses or densities.

### DESCRIPTION OF THE RELATED ART

Historically, mattresses have been filled with a variety of natural materials, including straw, a solid pack of hair, cotton-wool and feathers. Modern mattresses usually contain an inner spring core and/or materials such as rubber, latex or viscoelastic-type or other polyurethane-type foams. Such foam materials, preferably configured as a thick or thin foam pad having a top surface contoured with convolutions or raised and lowered areas extending over part or the entire top surface of the foam pad, have been found to have certain desirable qualities such as durability, resistance to packing and lumping, comfort, and a desired resilience.

However, the stiffness or density of the foam pad is the same over the entire extent of the pad with no particular consideration given to heavier parts of a human body, such as the torso. The entire foam pad is made of a single piece construction with the same density of foam throughout. The human body, because of its nonuniform weight distribution, rests more comfortably on a foam pad wherein the resistance to body pressure is differentially disposed according to the weight variation in different parts of the body. For example, greater resistance could be provided in a middle section of the mattress pad that supports the torso than in opposite end sections that support the head and legs of the body. Such differential resistance would foster greater comfort and resist backaches and sores, especially for bedridden patients.

Efforts have been made to provide a foam pad with areas of differential resistance to weight, for example, by strategically placing cushions and pillows under one's back. However, such cushions and pillows invariably shift in position during use. Also, each human body is different in weight, height and size, and a foam pad configured for one person is typically unsuitable for another. Also, each person's support requirements change over time. A lack of customization promotes user discomfort, backaches and body sores.

### OBJECTS OF THE INVENTION

It is an object of the present invention to provide a readily customizable foam pad, especially a mattress or mattress topper, which can be used by persons of varying weights, heights and sizes, or by one person whose support needs change over time, by changing at least one section of the pad to differentially resist weight, as desired, to increase user comfort.

Another object of the present invention is to provide a mattress foam pad wherein one or more of its sections, for example, a middle supporting section, is changeable, preferably to provide greater resistance for supporting the heavier torso of the human body, and to provide lesser resistance in end sections of the pad for supporting the relatively lighter head and legs of the human body.

Still another object of the present invention is to provide a mattress foam pad wherein one or more of its sections, for example, an end section, is changeable, preferably to provide lesser resistance for supporting the relatively lighter head and legs of the human body, and to provide greater resistance in a middle supporting section of the pad for supporting the relatively heavier torso of the human body.

### FEATURES OF THE INVENTION

According to one aspect of this invention, a foam pad includes a plurality of pad sections extending lengthwise along a longitudinal axis and widthwise along a transverse axis generally perpendicular to the longitudinal axis to assume a generally rectangular shape. The pad sections are together operative for supporting body portions of a user resting on the pad sections in a use condition. Two of the pad sections are end sections spaced longitudinally apart along the longitudinal axis. At least one, and preferably both, of the end sections are constituted of a foam material having a predetermined density. Another of the pad sections is a middle section constituted of a foam material having a density different from the predetermined density.

In accordance with this invention, the middle section is interlocked with one of the pad sections and is located between the end sections in the use condition for supporting at least one of the body portions of the user to a different extent than the end sections. For example, the density of the middle section can be greater or less than the predetermined density of the end sections, so that different body portions, such as the user's torso, head or legs, can be supported as desired.

In one embodiment, the middle section is interlocked with at least one, and preferably both, of the end sections. Advantageously, a plurality of undercut projections are provided on the middle section or the end sections, and a corresponding plurality of undercut recesses are provided on the end sections or the middle section for closely receiving the undercut projections with an interlocking fit.

In another embodiment, another of the pad sections is a main section integral with, and extending between, the end sections. The middle section is interlocked with the main section. In one construction, the main section has a single recess extending along the transverse axis, and the middle section has at least one slide projection closely received in the recess with an interlocking sliding fit. Each end section has an upper surface having a contour, and the middle section has an upper surface having a contour complementary to the contour of the upper surface of each end section. The upper surface of each end section and the upper surface of the middle section can be flat, but preferably, the upper surface of each end section and the upper surface of the middle section has a plurality of convolutions or pockets extending linearly along the transverse axis in mutual parallelism, preferably across the entire width of the foam pad.

In another construction, the main section has a plurality of recesses each extending along the transverse axis. The middle section includes a plurality of inserts respectively received in the recesses with an interlocking sliding fit. Preferably, each insert has a lower part received in a respective recess, an upper part outside of the respective recess, and an upright part connecting the lower and upper parts.

In all embodiments, friction between the middle section and its interlocked pad section resists shifting during use. By selecting the density of the middle section, e.g., a particular insert or a plurality of inserts, to be higher or lower than the predetermined density, and/or by selecting in which recess to receive a particular insert, a user can customize the foam pad for maximum comfort and support.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a foam pad according to the present invention;

FIG. 2 is a sectional view of another embodiment of a foam pad according to the present invention;

FIG. 3 is a sectional view of still another embodiment of a foam pad according to the present invention; and

FIG. 4 is an enlarged view of a detail of FIG. 3.

### DETAILED DESCRIPTION OF THE PREFERRED EMBODIMENTS

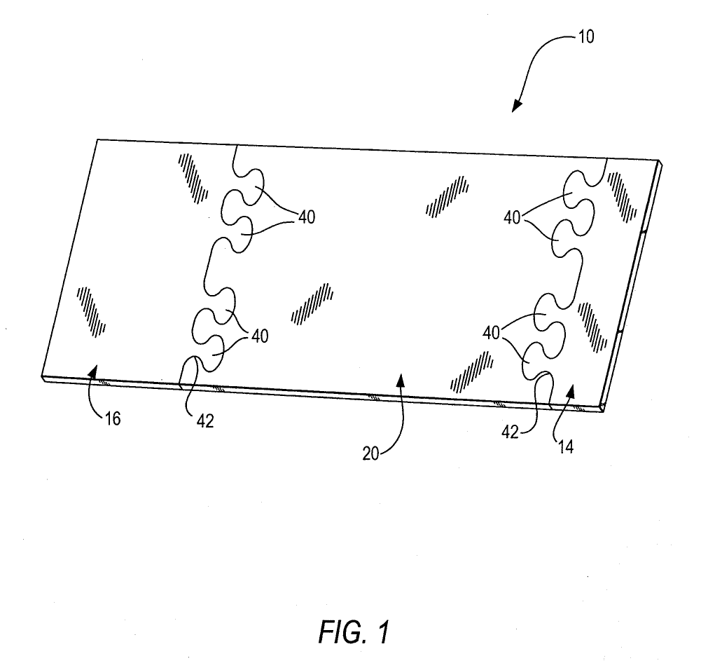

Referring to FIG. 1 of the drawings, a foam pad 10 includes a plurality of pad sections 14, 16, 20 each constituted of a foam material. The pad 10 may have a full thickness, e.g., greater than about six inches, to advantageously serve as a mattress, or a thin thickness, e.g., less than about six inches, to advantageously serve as a mattress topper that rests on top of a mattress. The pad 10 need not only be used for bedding, but could also be used in furniture, such as a sofa or padded chair. The pad sections 14, 16, 20 extend lengthwise along a longitudinal axis and widthwise along a transverse axis generally perpendicular to the longitudinal axis to assume a generally rectangular shape. The length of the pad 10 is greater than its width. The pad sections 14, 16, 20 are together operative for supporting body portions of a user resting or reclining on the pad sections in a use condition, e.g., during sleep.

Two of the pad sections are end sections 14, 16 spaced longitudinally apart along the longitudinal axis. At least one, and preferably both, of the end sections 14, 16 are constituted of a foam material having a predetermined density. Another of the sections is a middle section 20 constituted of a foam material having a density different from the predetermined density.

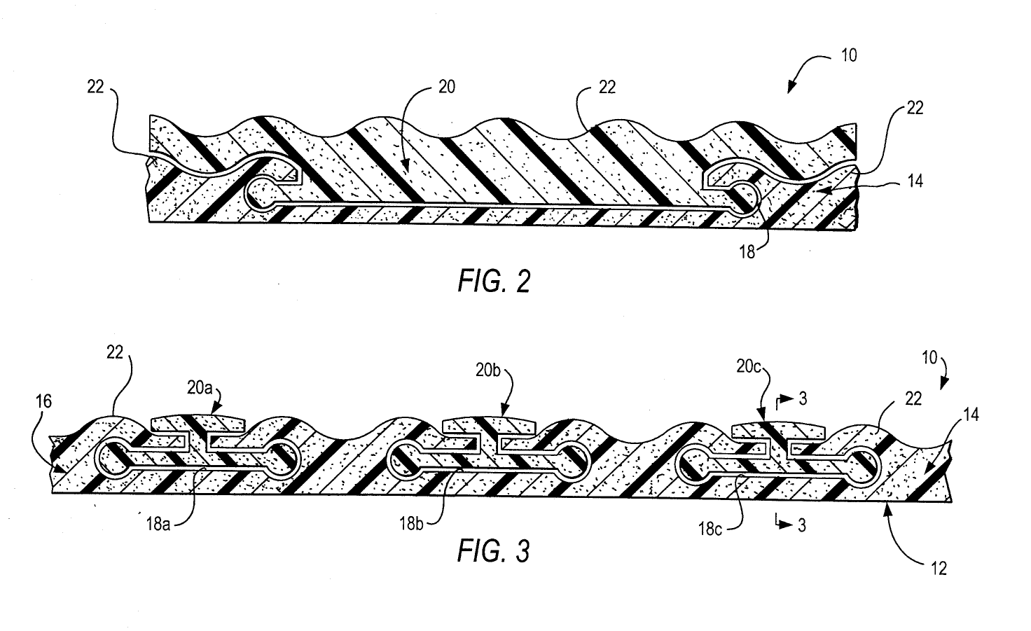

In accordance with this invention, the middle section 20 is interlocked with one of the pad sections, e.g., the end sections 14, 16 as shown in FIG. 1, or a main section 12 as shown and described below in connection with FIGS. 2-4. The middle section 20 is located between the end sections 14, 16 in the use condition for supporting at least one of the body portions of the user to a different extent than the end sections. For example, the density of the middle section 20 can be greater or less than the predetermined density of the end sections 14, 16, so that different body portions, such as the user's torso, head or legs, can be supported as desired.

In FIG. 1, the middle section 20 is interlocked with at least one, and preferably both, of the end sections 14, 16. Advantageously, a plurality of undercut or mushroom-shaped projections 40 are provided on the end sections 14, 16, and a corresponding plurality of undercut or mushroom-shaped recesses 42 are provided on the middle section 20 for closely receiving the undercut projections 40 with an interlocking snug fit. The projections 40 could also have been provided on the middle section 20, in which case, the recesses 42 would be provided on the end sections 14, 16. One or more of the projections 40 could be intermixed with one or more of the recesses 42. The projections 40 and the recesses 42 are spaced apart along the transverse axis, either equidistantly or not. Each projection 40 may have a shape other than the one illustrated. The projections 40 may have different shapes from one another.

In the embodiments of FIGS. 2-4, the aforementioned main section 12 is integral with, and extends between, the end sections 14, 16. The middle section 20 of FIG. 2 is interlocked with the main section 12. The main section 12 has a single recess 18 extending along the transverse axis across the entire width of the pad 10. The middle section 20 has at least one slide projection closely received in the recess 18 with an interlocking sliding fit. Each end section 14, 16 has an upper surface having a contour, and the middle section 20 has an upper surface having a contour complementary to the contour of the upper surface of each end section 14, 16. The upper surface of each end section 14, 16 and the upper surface of the middle section 20 can be flat, but preferably, the upper surface of each end section 14, 16 and the upper surface of the middle section 20 has a plurality of convolutions 22 or pockets extending linearly along the transverse axis in mutual parallelism, preferably across the entire width of the foam pad 10. The convolutions 22 have peaks that are approximately co-planar, as well as valleys that are likewise approximately co-planar.

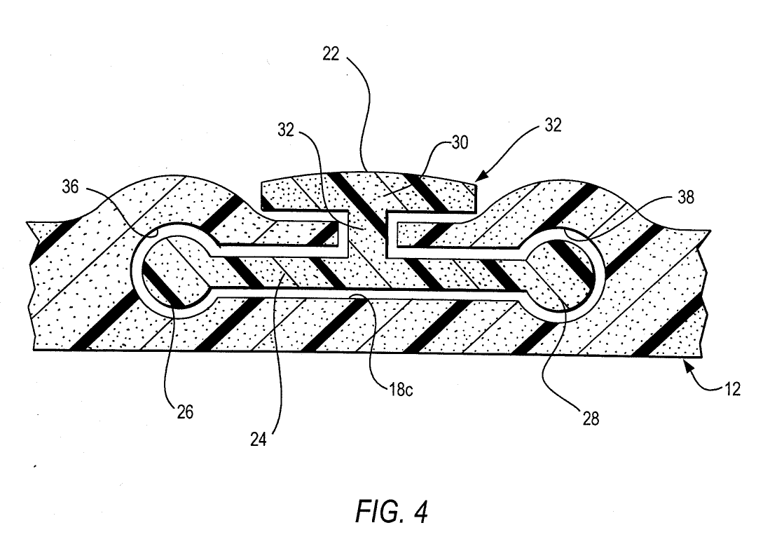

In FIGS. 3-4, the main section 12 has a plurality of recesses 18a, 18b, 18c each extending along the transverse axis, preferably across the entire width of the pad 10. The middle section 20 includes a corresponding plurality of inserts 20a, 20b, 20c respectively received in the recesses 18a, 18b, 18c with an interlocking sliding fit. An upper top surface of the main section 12 and an upper top surface of the end sections 14, 16 can be flat, but it is advantageous if these upper top surfaces are contoured, for example, with convolutions 22 or pockets, and if an upper surface of each insert 20a, 20b, 20c is also complementarily contoured. Each convolution 22 extends linearly along the transverse axis, preferably across the entire width of the pad 10. All the linear convolutions 22 are generally parallel to one another. The convolutions 22 have peaks that are approximately co-planar, as well as valleys that are likewise approximately co-planar.

As best shown in FIG. 4 for representative insert 20c in its representative recess 18c, each insert is generally roughly shaped like the letter “I” and has a lower horizontal part 24 extending between opposite bulbous ends 26, 28, an upper horizontal part 30 whose top surface is convex to match the contour of the convolutions 22 on the end sections 14, 16, and an upright part 32 connecting the horizontal parts 24, 30. Each recess is configured to have a contour complementary to the lower horizontal part 24 and has rounded cavities 36, 38 to closely receive the bulbous ends 26, 28.

In all embodiments, friction between the interlocked middle section 20 and the pad sections 12, 14, 16 resists shifting during use. Sometimes, it may be desired to permanently connect one or more sections to each other, for example, by adhesion or by sewing. By selecting the density of the middle section 20, e.g., a particular insert or a plurality of inserts 20a, 20b, 20c, to be higher or lower than the predetermined density, and/or by selecting in which recess 18a, 18b, 18c to receive a particular insert 20a, 20b, 20c, a user can customize the foam pad 10 for maximum comfort and support.

As described above, the pad 10 is preferably constituted of polyurethane foam, especially a visco-elastic polyurethane foam, also known as memory foam. The insert or middle section that supports the user's torso is of a different density than the end sections 14, 16 that support the user's head and legs. Density or firmness (hard to soft) of memory foam is typically measured by a foam's indentation force deflection (IFD) rating. IFD is a measure of the force (in pounds) required to make a dent 1 inch deep into a foam sample 15″×15″×4″ by an 8 inch diameter (50 square inch) disc. IFD ratings for memory foams range between super soft (IFD 10) and semi-rigid (IFD 12) and firm (IFD 12 to IFD 16). The degree of foam firmness at different compressions is affected by density and the particular chemical formulation of the foam. Higher density foams having higher IFD ratings for each insert are invariably more satisfactory than lower density foams for the end or middle sections of the pad 10 for the reasons of increased support and decreased fatigue properties.

It will be understood that each of the elements described above, or two or more together, also may find a useful application in other types of constructions differing from the types described above.

While the invention has been illustrated and described as a mattress pad, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A foam pad, comprising:
a plurality of pad sections extending longitudinally along a longitudinal axis and along a transverse axis generally perpendicular to the longitudinal axis and operative for supporting body portions of a user resting on the pad sections in a use condition,
two of the pad sections being end sections spaced apart along the longitudinal axis, at least one of the end sections being constituted of a foam material having a predetermined density; and
another of the pad sections being a middle section constituted of a foam material having a density different from the predetermined density, the middle section being interlocked with one of the pad sections and being located between the end sections in the use condition for supporting at least one of the body portions of the user to a different extent than the at least one end section.

2. The foam pad of claim 1, wherein the middle section is interlocked with the at least one end section.

3. The foam pad of claim 1, wherein the middle section is interlocked with both of the end sections.

4. The foam pad of claim 2, wherein one of the middle section and the at least one end section has at least one undercut projection, and wherein the other of the middle section and the at least one end section has at least one undercut recess for receiving the at least one undercut projection with an interlocking fit.

5. The foam pad of claim 1, wherein another of the pad sections is a main section integral with, and extending between, the end sections, and wherein the middle section is interlocked with the main section.

6. The foam pad of claim 5, wherein the main section has a single recess extending along the transverse axis, and wherein the middle section has at least one slide projection received in the recess with an interlocking sliding fit.

7. The foam pad of claim 5, wherein each end section has an upper surface having a contour, and wherein the middle section has an upper surface having a contour complementary to the contour of the upper surface of each end section.

8. The foam pad of claim 7, wherein the upper surface of each end section and the upper surface of the middle section has a plurality of convolutions extending along the transverse axis in mutual parallelism.

9. The foam pad of claim 5, wherein the main section has a plurality of recesses each extending along the transverse axis, and wherein the middle section includes a plurality of inserts respectively received in the recesses with an interlocking sliding fit.

10. The foam pad of claim 9, wherein each insert has a lower part received in a respective recess, an upper part outside of the respective recess, and an upright part connecting the lower and upper parts.
